(19) United States
(12) Patent Application Publication
(10) Pub. No.: US 2006/0104386 A1
(43) Pub. Date: May 18, 2006

(54) Quadrature voltage controlled oscillator for global positioning system frequencies

(75) Inventor: Christopher R. Leon, Irvine, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: u-Nav Microelectronics Corporation

(21) Appl. No.: 11/271,023

(22) Filed: Nov. 10, 2005

Related U.S. Application Data
(60) Provisional application No. 60/627,468, filed on Nov. 12, 2004.

(51) Int. Cl. H04L 27/22

(52) U.S. Cl. 375/332

(57) ABSTRACT

A quadrature voltage controlled oscillator that generates both in-phase and quadrature signals. The in-phase signal is generated by directly coupling two oscillators, while the quadrature phase signal is generated by cross-coupling the two oscillators.

### CROSS-REFERENCE TO RELATED APPLICATIONS

This application claims the benefit under 35 U.S.C. Section 119(e) of co-pending and commonly-assigned U.S. provisional patent application Ser. No. 60/627,468, filed Nov. 12, 2004, entitled “QUADRATURE VOLTAGE CONTROLLED OSCILLATOR FOR GLOBAL POSITIONING SYSTEM FREQUENCIES,” by Christopher R. Leon, which application is incorporated by reference herein.

### BACKGROUND OF THE INVENTION

1. Field of the Invention

The present invention relates generally to Global Positioning System (GPS) receivers, and in particular, to a quadrature voltage controlled oscillator for GPS frequencies.

2. Description of the Related Art

The use of GPS in consumer products has become commonplace. Hand-held devices used for mountaineering, automobile navigation systems, and GPS for use with cellular telephones are just a few examples of consumer products using GPS technology.

As GPS technology is being combined with these devices, the GPS chips are being placed in widely ranging temperature environments. Further, some of the GPS portions are being made on the same semiconductor chip as other portions of the combined devices, which subjects the GPS portions of these electronic devices to widely-varying semiconductor processing steps. Since the GPS portion of the chips are temperature and process dependent, it becomes more difficult to produce a large yield of semiconductor chips with GPS functionality.

One of the temperature and process dependent portions of the GPS functionality is the in-phase (I) and quadrature-phase (Q) signal generator that are required for GPS quadrature modulation and demodulation. As the temperature of the chip changes, or the processing across the wafer changes, the I and Q signals become mismatched, which introduces errors in the GPS calculations.

Further, because GPS usage has been placed in new products, other issues, such as lower signal strength of the received signals has become an issue. Mismatches between the I and Q signals makes it more difficult for a GPS receiver to resolve signals of lower received signal strength.

It can be seen, then, that there is a need in the art for a device that can generate I and Q signals that is less temperature dependent. It can also be seen that there is a need in the art for a device that can generate I and Q signals that is less process dependent.

### SUMMARY OF THE INVENTION

To minimize the limitations in the prior art, and to minimize other limitations that will become apparent upon reading and understanding the present specification, the present invention discloses a quadrature voltage controlled oscillator for GPS frequencies. Where the related art uses a single Voltage Controlled Oscillator (VCO), the present invention uses two VCOs, and generates the I and Q signals directly. The in-phase signal is generated by direct coupling of the two VCO outputs, and the quadrature phase signal is generated by cross-coupling the two VCO outputs.

A device in accordance with the present invention comprises a first voltage controlled oscillator, a second voltage controlled oscillator, and a coupler, coupled between the first voltage controlled oscillator and the second voltage controlled oscillator, wherein the coupler directly couples the first voltage controlled oscillator and the second voltage controlled oscillator to produce the in-phase signal, and wherein the coupler cross-couples the first voltage controlled oscillator and the second voltage controlled oscillator to produce the quadrature-phase signal.

### BRIEF DESCRIPTION OF THE DRAWINGS

Referring now to the drawings in which like reference numbers represent corresponding parts throughout:

FIG. 1 illustrates a block diagram of the related art;

FIG. 2 illustrates a block diagram of the present invention;

FIG. 3 illustrates an embodiment of the present invention;

FIG. 4 illustrates the outputs and coupling of the embodiment of the present invention;

FIG. 5 illustrates the magnitude and phase of the impedance peaks for the tank used in the present invention;

FIG. 6 illustrates the output signals of the present invention; and

FIG. 7 illustrates a GPS receiver in accordance with the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

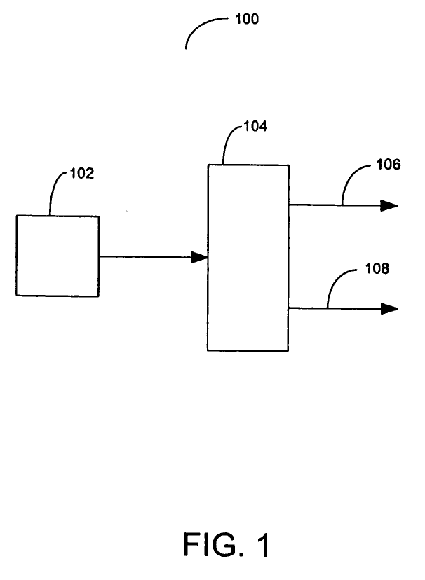

FIG. 1 illustrates a block diagram of the related art.

System 100 illustrates a Voltage Controlled Oscillator 102 and I/Q generator 104. VCO 102 typically outputs a frequency to I/Q generator 104, which generates the in-phase (I) signal 106 and the quadrature-phase (Q) signal 106.

Processing of the I/Q generator 104 is very difficult because small processing changes from chip to chip, or temperature changes on the chip, affect both the output of VCO 102 and the balance of the I signal 106 and Q signal 108. As such, other circuitry must be placed in the system 100 to compensate for variations in the I signal 106 and Q signal 108.

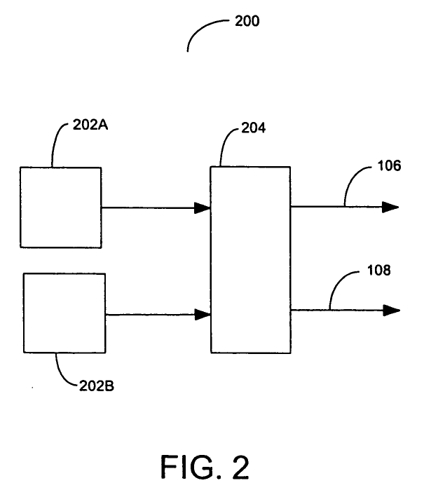

FIG. 2 illustrates a block diagram of the present invention.

System 200 of the present invention illustrates two Voltage Controlled Oscillators 202A and 202B and a combiner 104. VCOs 202A-B each generate a specific frequency which are output to combiner 204. Combiner 204 generates the I signal 106 and Q signal 108 by combining the output of VCOs 202A-B in different ways. To generate the I signal 106, combiner 204 directly couples the outputs of VCOs 202A and 202B. To generate the Q signal 108, the combiner 204 cross-couples the outputs of VCOs 202A and 202B.

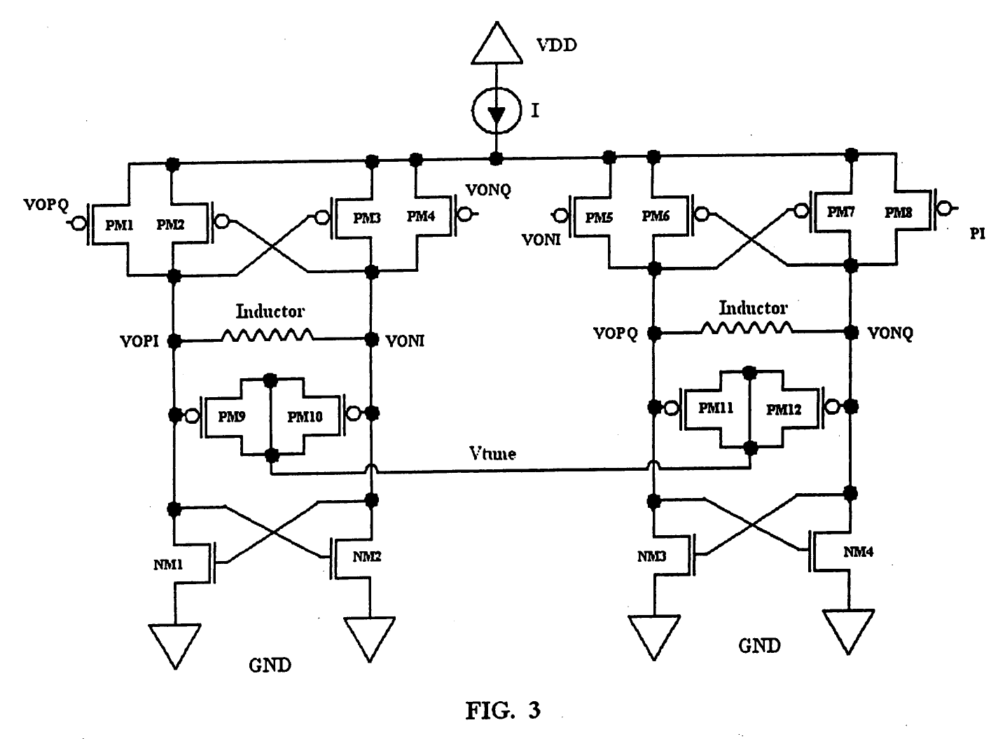

FIG. 3 illustrates an embodiment of the present invention.

The quadrature VCO generates the required quadrature signals by coupling two identical VCO's (VCO1 and VCO2) as shown in FIG. 3. The core VCO comprises a cross-coupled pair of common source NMOS devices (NM1 and NM2 for VCO1, NM3 and NM4 for VCO2) and a cross-coupled pair of common source PMOS devices (PM2 and PM3 for VCO1, PM6 and PM7 for VCO2) with inductor loads and a variable capacitor formed using PMOS devices (PM9 and PM10 for VCO1, PM11 and PM12 for VCO2), where the gate is connected to the output while the drain, the source, and the bulk are connected to the tuning voltage. The cross-coupled MOSFETS present a differential negative resistance to the on chip inductor load which will resonate at the desired frequency.

When the cross-coupled MOSFETS are in saturation they generate a negative resistance, and when they go off or to the triode region the resistance becomes positive. To guarantee start up, the VCOs are designed with extra negative resistance to maintain oscillation.

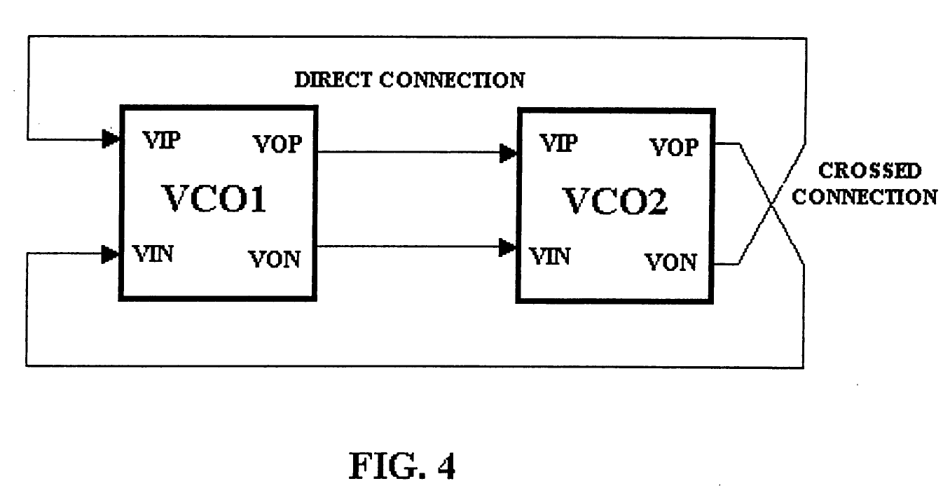

The two identical VCO's which oscillate at the same frequency are coupled together through PMOS devices PM1, PM4, PM5, and PM8, forcing the two VCO's to operate in quadrature. This behavior is accomplished by coupling VCO1 to VCO2 through PM5 and PM8 in a direct connection, while VCO2 is cross-connected to VCO1 through PM1 and PM4. The direct connection and cross-connections between VCO1 and VCO2 are shown in FIG. 4.

By using this direct connection and the crossed connection it forces VCO2 outputs to lag by 90 degrees the outputs of VCO1, as shown in the following mathematical derivation.

To simplify the derivations, each VCO is converted to a single cross coupled transconductance; gmain, coupled to the other VCO with gcoupler, and with the LCR tank as the load, then we have:
gmain=gm_{NMOS}+gm_{PMOS} eq. 1
gcoupler=gm_{PMOSC} eq. 2

Where gm_{NMOS} is the transconductance of the NMOS devices NMOS1, NMOS2, NMOS3, and NMOS4, while gm_{PMOS} is the transconductance of the PMOS devices PMOS2, PMOS3, PMOS6, and PMOS7. The coupling device gm_{PMOSC} is the transconductance of the PMOS devices PMOS1, PMOS4, PMOS5, and PMOS8.

The tank Zt is the parallel combination of an inductor L, a capacitor C, and an equivalent resistor R that represents the tank loss.

Using equations 1 and 2, with the tank impedance Zt, the outputs of the QVCO are given by the following equations:
VOPI=(−gmain*VONI−gcoupler*VOPQ)*Zt eq. 3
VONI=(−gmain*VOPI−gcoupler*VONQ)*Zt eq. 4
VOPQ=(−gmain*VONQ−gcoupler*VONI)*Zt eq. 5
VONQ=(−gmain*VOPQ−gcoupler*VOPI)*Zt eq. 6
The equations 3, 4, 5, and 6 can be arranged in the following matrix equation:

$$[ \begin{matrix}1 & gmain * Zt & gcoupler * Zt & 0 \\ gmain * Zt & 1 & 0 & gcoupler * Zt \\ 0 & gcoupler * Zt & 1 & gmain * Zt \\ gcoupler * Zt & 0 & gmain * Zt & 1\end{matrix} ] [ \begin{matrix}VOPI \\ VONI \\ VOPQ \\ VONQ\end{matrix} ] = [ \begin{matrix}0 \\ 0 \\ 0 \\ 0\end{matrix} ]$$

The determinant of the matrix is equal to zero, but the outputs are not, then:
1−2*gmain²*Zt²+4*gmain*gcoupler²*Zt³+gmain⁴*Zt⁴−gcoupler⁴*Zt⁴=0 eq. 7
To simplify the equation:

$$\begin{matrix}CF = \frac{gcoupler}{gmain} , & coupling factor \\ Gain = gmain * Zt , & gain\end{matrix}$$

Equation 7 has two solutions, which are given in equations 8 and 9:

$$\begin{matrix}Gain = \frac{- 1}{1 \pm CF} & eq . 8 \\ Gain = \frac{- 1}{1 \pm j CF} & eq . 9\end{matrix}$$

Since quadrature is the desired behavior, the complex solution given by equation 9 is utilized and replaced in equations 3, 4, 5, and 6 to resolve them. The results are:
VOPI=VOPI eq. 10
VONI=−VOPI eq. 11
VOPQ=∓jVOPI eq. 12
VONQ=±jVOPI eq. 13

With these results it is shown that the QVCO has two modes of oscillation. In mode 1, the output VOPQ−VONQ lags the output VOPI−VONI by 90 degrees, as shown by the negative part of equation 12 (VOPQ=−jVOPI), and the positive part of equation 13 (VONQ=jVOPI), where it oscillates at the frequency W₁ with a gain given by equation 14.

$$Gain = \frac{1}{\sqrt{1 + {CF}^{2}}} exp ( - j * {tan}^{- 1} ( CF ) ) \qquad eq . 14$$

In mode 2, the output VOPI-VONI lags the output VOPQ−VONQ by 90 degrees, as shown by the positive part of equation 12 (VOPQ=j VOPI), and the negative part of equation 13 (VONQ=−jVOPI), where it oscillates at the frequency W₂ with a gain given by the equation 15.

$$Gain = \frac{1}{\sqrt{1 + {CF}^{2}}} exp ( j * {tan}^{- 1} ( CF ) ) \qquad eq . 15$$

The lossy LC tank, Zt oscillates at the frequency given by equation 16.

$${W}_{r} = \frac{1}{\sqrt{LC}} \sqrt{1 - \frac{C * {r}^{2}}{L}} \qquad eq . 16$$

Where r is the inductor loss.

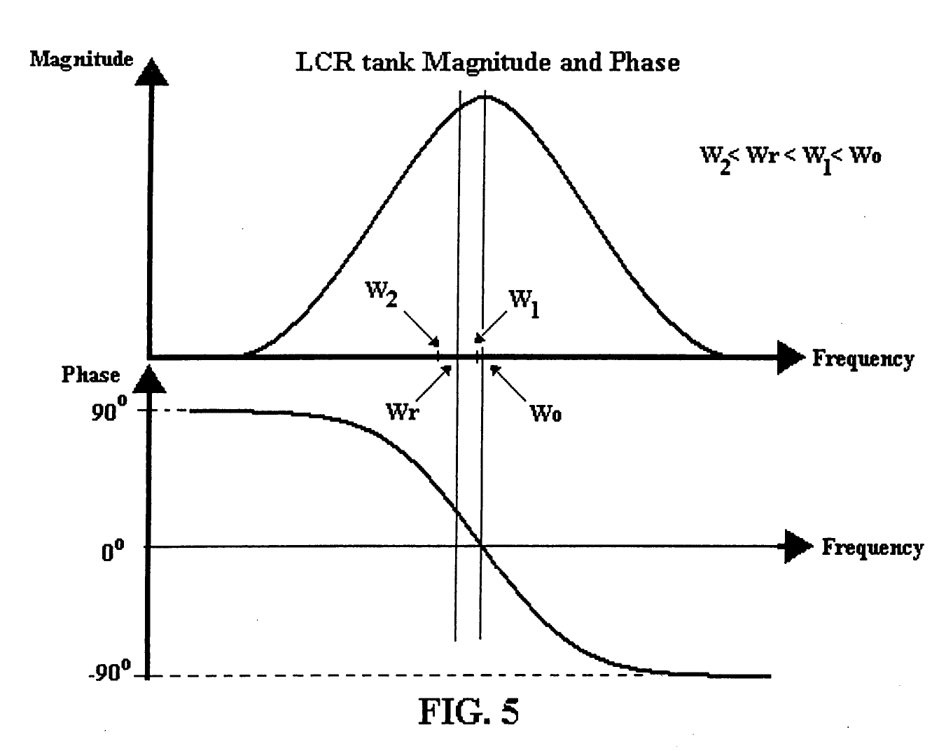

FIG. 5 illustrates the magnitude and phase of the impedance peaks for the tank used in the present invention.

For an oscillator with lossy inductor, the magnitude of the impedance peaks at a frequency higher than the resonant frequency Wr of the tank, as shown in FIG. 5, due to the negative resistance behavior of the VCO which cancels out the equivalent resistance of the tank, the VCOs will oscillate at the highest gain, which occurs in mode 1, and will be very close to the ideal frequency of oscillation given by equation 17.

$${W}_{o} = \frac{1}{\sqrt{LC}} \qquad eq . 17$$

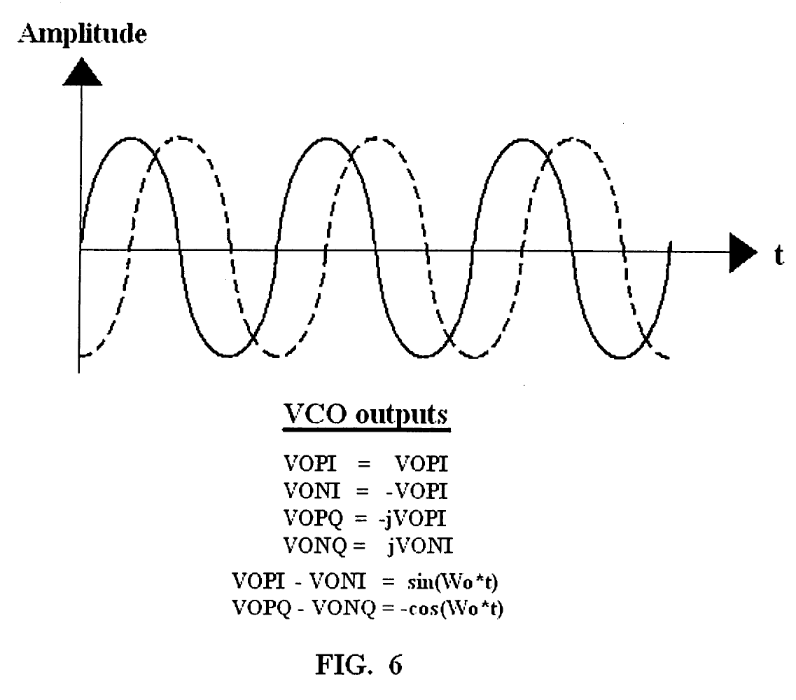

Since mode 1 dominates then the outputs of the QVCO will look like the ones shown in FIG. 6.

Because the VCOs are identical, and can be located physically near each other on the chip, the process and temperature differences between the two VCOs do not differentially affect the outputs of the VCOs. Further, because the circuitry for the remainder of the quadrature signal generator converter is also located physically proximate to the VCOs, temperature and process differences across a given wafer (chip-to-chip) or from wafer to wafer are minimized, and a system utilizing the system of the present invention becomes less temperature and process dependent.

Although shown as a separate circuit, the system of the present invention is typically used as part of a GPS receiver. Further, a system in accordance with the present invention can be used in other devices that require in-phase and quadrature-phase signals where a fixed quadrature amplitude and fixed phase difference are acceptable.

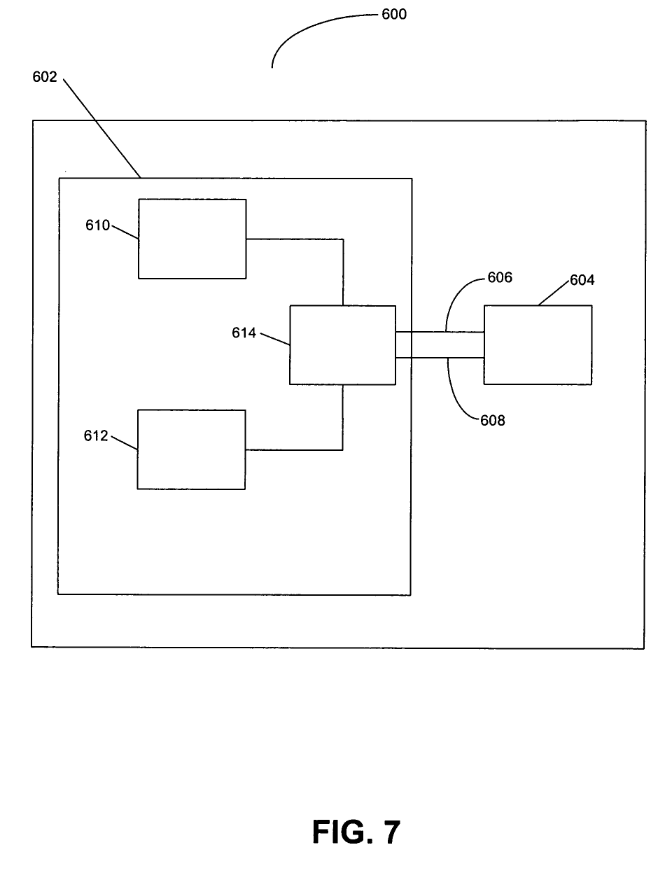

FIG. 7 illustrates a GPS receiver in accordance with the present invention.

Since the system and device of the present invention are typically part of a GPS receiver, receiver 600 is shown, which comprises a Radio Frequency (RF) portion 602 and baseband portion 604. Typically RF portion 602 and baseband portion 604 are on separate integrated circuit chips, but can be on a single chip if desired. The RF portion 602 generates several outputs, which include at least an in-phase signal 606 and a quadrature phase signal 608. The baseband portion 604 is coupled to RF portion 602 and receives the in-phase signal 602 and the quadrature phase signal 604.

the in-phase signal 606 and the quadrature-phase signal 608 are generated by a first voltage controlled oscillator 610, a second voltage controlled oscillator 612, and a coupler 614, coupled between the first voltage controlled oscillator 610 and the second voltage controlled oscillator 612. Coupler 614 couples the first voltage controlled oscillator and the second voltage controlled oscillator in a first manner to produce the in-phase signal 606, and couples the first voltage controlled oscillator 610 and the second voltage controlled oscillator 612 in a second manner to produce the quadrature-phase signal 608.

Although shown as Metal-Oxide-Semiconductor (MOS) devices, the devices within the system of the present invention can be bipolar devices. Further, the MOS devices can be of N-type (NMOS) or P-type (PMOS), a mixture of NMOS and PMOS, or true Complimentary MOS (CMOS).

### CONCLUSION

In summary, a device in accordance with the present invention comprises a first voltage controlled oscillator, a second voltage controlled oscillator, and a coupler, coupled between the first voltage controlled oscillator and the second voltage controlled oscillator, wherein the coupler directly couples the first voltage controlled oscillator and the second voltage controlled oscillator to produce the in-phase signal, and wherein the coupler cross-couples the first voltage controlled oscillator and the second voltage controlled oscillator to produce the quadrature-phase signal.

Such a device optionally further includes being used in a GPS receiver, using MOS transistors of either P-type or N-type MOS, or both P-type and N-type MOS transistors.

A GPS receiver in accordance with the present invention comprises a Radio Frequency (RF) portion, the RF portion generating at least an in-phase signal and a quadrature phase signal, and a baseband portion, coupled to the RF portion, for receiving the in-phase signal and the quadrature phase signal, wherein the in-phase signal and the quadrature-phase signal are generated by a first voltage controlled oscillator, a second voltage controlled oscillator; and a coupler, coupled between the first voltage controlled oscillator and the second voltage controlled oscillator, wherein the coupler couples the first voltage controlled oscillator and the second voltage controlled oscillator in a first manner to produce the in-phase signal, and wherein the coupler couples the first voltage controlled oscillator and the second voltage controlled oscillator in a second manner to produce the quadrature-phase signal.

Such a GPS receiver optionally further includes the RF portion being on a first chip and the baseband portion being on a second chip, the first voltage controlled oscillator and the second voltage controlled oscillator being designed using a single oscillator design, the first voltage controlled oscillator, the second voltage controlled oscillator, and the coupler being placed proximate to each other, the first voltage controlled oscillator and the second voltage controlled oscillator being coupled in the first manner by a first set of MOS transistors, and the first voltage controlled oscillator and the second voltage controlled oscillator are coupled in the second manner by a second set of MOS transistors.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and the equivalents thereof.

What is claimed is:

1. A device for generating an in-phase signal and a quadrature-phase signal, comprising:
a first voltage controlled oscillator;
a second voltage controlled oscillator; and
a coupler, coupled between the first voltage controlled oscillator and the second voltage controlled oscillator, wherein the coupler directly couples the first voltage controlled oscillator and the second voltage controlled oscillator to produce the in-phase signal, and wherein the coupler cross-couples the first voltage controlled oscillator and the second voltage controlled oscillator to produce the quadrature-phase signal.

2. The device of claim 1, wherein the device is used in a Global Positioning System receiver.

3. The device of claim 2, wherein the device uses metal-oxide-semiconductor (MOS) transistors.

4. The device of claim 3, wherein the MOS transistors are P-type MOS (PMOS) transistors.

5. The device of claim 3, wherein the MOS transistors are N-type MOS (NMOS) transistors.

6. The device of claim 3, wherein the MOS transistors comprise both P-type MOS (PMOS) transistors and N-type MOS (NMOS) transistors.

7. A Global Positioning System (GPS) Receiver, comprising:
a Radio Frequency (RF) portion, the RF portion generating at least an in-phase signal and a quadrature phase signal; and
a baseband portion, coupled to the RF portion, for receiving the in-phase signal and the quadrature phase signal, wherein the in-phase signal and the quadrature-phase signal are generated by:
a first voltage controlled oscillator;
a second voltage controlled oscillator; and
a coupler, coupled between the first voltage controlled oscillator and the second voltage controlled oscillator, wherein the coupler couples the first voltage controlled oscillator and the second voltage controlled oscillator in a first manner to produce the in-phase signal, and wherein the coupler couples the first voltage controlled oscillator and the second voltage controlled oscillator in a second manner to produce the quadrature-phase signal.

8. The GPS receiver of claim 7, wherein the RF portion is on a first chip and the baseband portion is on a second chip.

9. The GPS receiver of claim 8, wherein the first voltage controlled oscillator and the second voltage controlled oscillator are designed using a single oscillator design.

10. The GPS receiver of claim 9, wherein the first voltage controlled oscillator, the second voltage controlled oscillator, and the coupler are placed proximate to each other on the first chip.

11. The GPS receiver of claim 7, wherein the first voltage controlled oscillator, the second voltage controlled oscillator, and the coupler are placed proximate to each other.

12. The GPS receiver of claim 7, wherein the first voltage controlled oscillator and the second voltage controlled oscillator are coupled in the first manner by a first set of MOS transistors.

13. The GPS receiver of claim 12, wherein the first voltage controlled oscillator and the second voltage controlled oscillator are coupled in the second manner by a second set of MOS transistors.
